(19) United States
(12) Patent Application Publication
(10) Pub. No.: US 2014/0138250 A1
(43) Pub. Date: May 22, 2014

(54) ALUMINUM WHEEL AND METHOD FOR PRODUCING THE SAME

(71) Applicants: HYUNDAI MOTOR COMPANY, Seoul (KR); KIA MOTORS CORPORATION, Seoul (KR)

(72) Inventors: Kwang Min Yoon, Hwaseong (KR); Min Soo Kim, Hwaseong (KR)

(73) Assignees: KIA MOTORS CORPORATION, Seoul (KR); HYUNDAI MOTOR COMPANY, Seoul (KR)

(21) Appl. No.: 13/841,917

(22) Filed: Mar. 15, 2013

(30) Foreign Application Priority Data
Nov. 16, 2012 (KR) 10-2012-0129855

(51) Int. Cl. B60B 19/00; B22D 25/02

(52) U.S. Cl. CPC B60B 19/00; B22D 25/02
USPC 205/50; 164/47; 164/76.1; 420/532

(57) ABSTRACT

Disclosed is an aluminum wheel comprising: Al as a major ingredient, Si: about 0˜2 wt % (excluding 0), Fe: about 0˜0.15 wt% (excluding 0), Cu : about 0.5˜1 wt %, Mn: about 0.03˜0.2 wt %, Mg: about 0.8˜1.2 wt %, Cr: about 0.05˜0.35 wt %, Zn: about 0.2˜0.6 wt %, Ti: about 0.01˜0.1 wt %, Sr: about 0.001˜0.05 wt %, P: about 0˜0.001 wt % (excluding 0) and inevitable impurities; and a method for producing the same.

### CROSS-REFERENCE TO RELATED APPLICATION

This application claims under 35 U.S.C. §119(a) the benefit of Korean Patent Application No. 10-2012-0129855 filed Nov. 16, 2012 the entire contents of which are incorporated herein by reference.

### BACKGROUND

(a) Technical Field

The present invention relates to a lightweight aluminum wheel which can be provided in various colors using a new low cost, high strength alloy, and methods for production thereof, particularly by applying an excellent anodizing technique.

(b) Background Art

An aluminum wheel is an important design part of vehicle exterior, and it can directly express features of vehicles. Therefore, many efforts focus on enhancing the external appearance thereof by various coating methods and surface treatment. Among these, there are many studies about color expression by using anodizing techniques, which can express various colors and can also provide a luxurious external appearance.

However, a conventionally used aluminum wheel casting material alloy (Al₇SiMg, A356) is difficult to coat using anodizing techniques due to a decreased anodizing quality caused by the high Si content therein. Further, leading global companies are developing wheels by applying anodizing to expensive aluminum wrought alloys (AlMgSi, A6082). However, the use these alloys for vehicle production is cost prohibitive.

Recent techniques for embodying various colors on an aluminum wheel surface focuses on coating techniques and plating techniques. In the case of using a coating technique on an aluminum wheel, while various colors can be used, the luxuriousness of the coating thus applied is inadequate. In the case of plating techniques, only limited colors can be applied and it is expensive.

The aluminum wheels which are used currently are prepared by using a cast alloy, Al₇SiMg (A356), in a low pressure casting process. The A356 alloy comprises a high content of Si (7%). The Si is provided as a major ingredient of a cast alloy for securing fluidity of the molten metal and for increasing strength. However, a high Si content is an obstacle for forming an Al₂O₃ layer in a subsequent anodizing process, and causes unevenness in the anodizing thickness and an uneven color expression.

Accordingly, the anodizing process has been conducted by using A6082 alloy (Si: 1 wt % or less) which contains a very small amount of Si. The A6082 alloy is a wrought alloy, which can't be casted. Thus, a wheel is produced using the A6082 alloy by a forging process followed by anodizing thereof to apply a desired color. However, A6082 alloy is expensive, and a hot forging process, which is the most expensive type of aluminum forming processes, should be used. Therefore, this process is cost prohibitive due to an increased production cost of about 300% as compared with conventional aluminum wheel fabrication.

KR 10-1 999-0041 520 A describes “surface treatment for aluminum wheel with auto and aluminum wheel with auto produced thereby”, and in particular “relates to a surface treatment method for an aluminum wheel for vehicles and the aluminum wheel for vehicles produced by the method.” As set out “Generally, there are two kinds of aluminum wheels for vehicles, a coated aluminum wheel and a plated aluminum wheel. The plated wheel is better than the coated wheel in terms of exterior design and quality, but it has a defect of high production cost because a polishing process, which is an essential process for plating in producing thereof, is very difficult by character of aluminum. Accordingly, the present invention has been made in an effort to solve the above-described problems associated with prior art, and is objected to produce a plated aluminum wheel with ease and low cost by replacing the polishing process, which is essential for plating, with a coating process so as to obtain the surface as fine as the surface obtained by polishing.”.

However, despite the described technique, KR 10-1999-0041520 A still suggests using the high cost plating technique.

Therefore, an aluminum wheel, which has beautiful exterior design and secures strength without requiring the use of complicates fabrication processes, and a method for producing the same are needed.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the above-described problems associated with prior art. The present invention provides an aluminum wheel, which can express various colors and which is fabricated of a new low cost, high strength alloy rather than a forged material, and methods for production thereof. According to embodiments of the present invention, by applying an excellent anodizing technique, merchantability of the aluminum wheel is improved and a more lightweight aluminum wheel than the conventional aluminum wheel can be provided.

According to various embodiments, the aluminum wheel according to the present invention comprises: Al as a major ingredient, Si: about 0˜2 wt % (excluding 0 wt %), Fe: about 0˜0.15 wt % (excluding 0 wt %), Cu: about 0.5˜1 wt %, Mn: about 0.03˜0.2 wt %, Mg: about 0.8˜1.2 wt %, Cr: about 0.05˜0.35 wt %, Zn: about 0.2˜0.6 wt %, Ti: about 0.01˜0.1 wt %, Sr: about 0.001˜0.05 wt %, P: about 0˜0.001 wt %(excluding 0) and inevitable impurities, wherein wt % are based on the total weight of the aluminum wheel. Further, when Al is referred to as a “major ingredient”, it is understood that Al is present at greater than about 50 wt %, greater than about 60 wt %, greater than about 70 wt %, greater than about 80 wt %, greater than about 85 wt %, or greater than about 90 wt %.

According to various embodiments, the aluminum wheel is produced by pouring molten metal from a rim part by using gravity tilt pour casting.

According to various embodiments, the aluminum wheel is color coated after anodizing treatment.

According to various embodiments, the aluminum wheel is color coated after anodizing treatment of the outer most designed face, which is exposed to the outside (i.e. which is visible when provided on a vehicle).

According to various embodiments, the aluminum wheel is coated followed by removing at least a portion of the coated layer of the outer most designed face, which is exposed to the outside, and then color coated again after anodizing treatment thereof. According to various embodiments, the entire coated layer is removed from the outer most face followed by color coating again after anodizing treatment thereof.

According to various embodiments, the method for producing the aluminum wheel comprises: a preparing step of preparing an aluminum alloy molten metal, which comprises: Al as a major ingredient, Si: about 0˜2 wt % (excluding 0), Fe: about 0˜0.15 wt % (excluding 0), Cu: about 0.5˜1 wt %, Mn: about 0.03˜0.2 wt %, Mg: about 0.8˜1.2 wt %, Cr: about 0.05˜0.35 wt %, Zn: about 0.2˜0.6 wt %, Ti: about 0.01˜0.1 wt %, Sr: about 0.001˜0.05 wt %, P: about 0˜0.001 wt %(excluding 0) and inevitable impurities, wherein wt % are based on the total weight of the aluminum wheel; and a casting step of producing the aluminum wheel by using a casting mold.

According to various embodiments, the casting step comprises using a gravity tilt pour casting device, and a molten metal can be poured from a rim part of the aluminum wheel mold.

According to various embodiments, the casting step further comprises a coating step of color coating the produced aluminum wheel after anodizing treatment thereof.

According to various embodiments, the casting step further comprises a coating step of: at least partially removing the coated layer from the out most designed face, which is exposed outside, after color coating the produced aluminum wheel; and then anodizing treatment thereof followed by color coating thereof again. According to various embodiments, the entire coated layer is removed from the outer most face followed by anodizing treatment and color coating.

According to various embodiments, the casting step further comprises a coating step of color coating the outer most designed face, which is exposed to the outside, after anodizing treatment thereof.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a drawing showing a casting process of the aluminum wheel according to one embodiment of the present invention;

FIG. 2 is a drawing showing a cut side of the aluminum wheel according to one embodiment of the present invention;

FIG. 3 is a perspective view of the aluminum wheel according to one embodiment of the present invention; and

FIG. 4 is a flow chart showing the method of producing the aluminum wheel according to one embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the aluminum wheel according to preferable embodiments of the present invention, and the method for producing thereof now will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

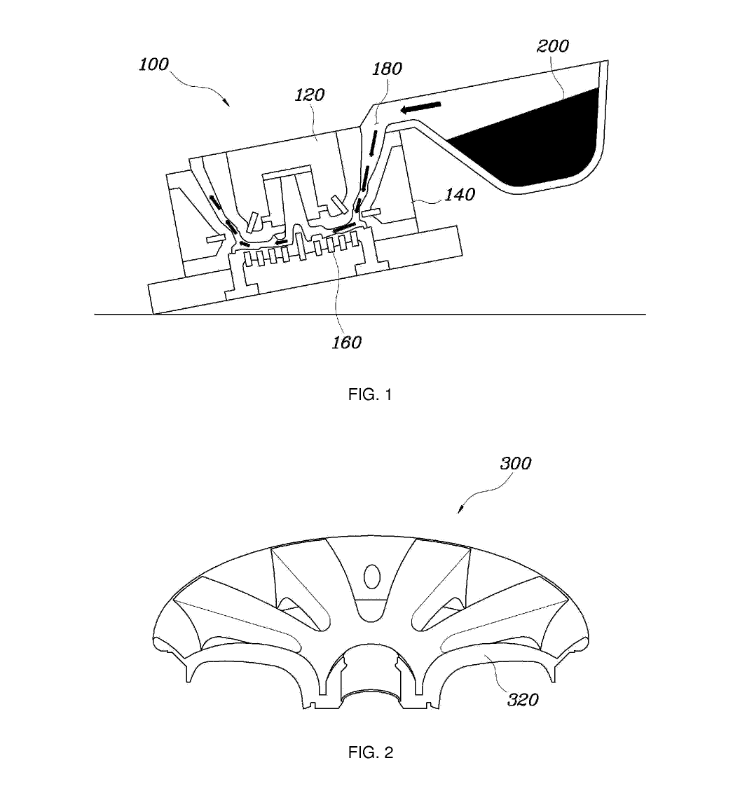

FIG. 1 is a drawing showing a casting process of the aluminum wheel according to one embodiment of the present invention. According to an exemplary embodiment, the aluminum wheel of the present invention comprises: Al as a major ingredient, Si: about 0˜2 wt % (excluding 0 wt %), Fe: about 0˜0.15 wt % (excluding 0 wt %), Cu: about 0.5˜1 wt %, Mn: about 0.03˜0.2 wt %, Mg: about 0.8˜1.2 wt %, Cr: about 0.05˜0.35 wt %, Zn: about 0.2˜0.6 wt %, Ti: about 0.01˜0.1 wt %, Sr: about 0.001˜0.05 wt %, P: about 0˜0.001 wt %(excluding 0 wt %) and inevitable impurities, wherein wt % are based on the total weight of the aluminum wheel.

The present invention relates to a lightweight, colored anodizing aluminum wheel. More particularly, the present invention relates to an aluminum wheel formed of a new low cost, high strength allow on which various colors can be expressed. The present invention further relates to applying an anodizing technique to form the aluminum wheel which is more lightweight aluminum wheel than conventional aluminum wheels and that have improved merchantability.

According to the present invention, an aluminum wheel is provided which comprises a low content of Si, particularly Si at an amount of 2 wt % or less. According to various aspects, the aluminum wheel is formed of a new allow which can be casted. An aluminum wheel and method for its production can, thus, comprise using casting process. The aluminum wheel of the present invention is provided with a good anodizing character, thus forming a beautiful gloss and high quality coating. According to the present invention, production costs can be lowered to about ⅓ or less than the production costs of conventional products.

Specifically, according to conventional techniques, in order to secure the desired anodizing character, general aluminum alloys for casting contain Si at an amount of about 7 wt %. However, this results in a high chance that anodizing uniformity and color expression will be unsatisfactory due to an Si deposit formed on the surface. Accordingly, the present invention secures anodizing uniformity and color clarity by limiting the amount of the Si, particularly to no greater than 2 wt %.

Further, according to conventional techniques, in order to solve the low fluidity problem of a molten metal caused by a low Si content, center-gate low pressure casting techniques are replaced with gravity tilt pour casting to thereby secure fluidity to the gravity direction. The fluidity is further secured by pouring the molten metal from an end of the rim part of the aluminum wheel towards the center to thereby pour from a thin-walled part to a thick-walled part.

According to embodiments of the present invention, in order to increase the strength of the aluminum wheel, which is reduced by low Mg₂Si caused by low Si content, Mg content was increased to secure excess Mg and to improve a solid solution strengthening effect. Further, a precipitation hardening effect was improved by increasing Cu content, and the solid solution strengthening effect was further improved by increasing Mn and Zn contents. Further, in terms of preventing cracking of the aluminum wheel under heightened temperatures, Cr was added at an amount of about 0.05˜0.35 wt % to prevent the hot cracking caused by low Si content.

According to various aspects, and as depicted in FIG. 1. the aluminum wheel of the present invention can be produced by pouring molten metal 200 from a rim part 180 by using a gravity tilt pour casting device 100. Conventionally, aluminum wheels are generally produced by low pressure casting. However, due to the lower Si content of the alloy used in the present invention, low pressure casting is difficult to carry out. Accordingly, the aluminum wheel of the present invention was produced by compensating the lowered fluidity with gravity casting by using the gravity tilt pour casting technique.

Moreover, the low pressure casting technique generally has a defect in that temperature is high around a hub where an inlet of the molten metal is provided. This negatively impacts the mechanical properties of the part. On the other hand, the gravity tilt pour casting technique of the present invention provides the rim part 180 as the inlet of the molten metal 200, and cooling channels 160 were further added to the hub, which is a relatively thick part. As a result, DAS (Dendrite Arm Spacing) is reduced which results in increased mechanical properties. Further, according to various embodiments, the cooling channels can be equally placed in an upper mold 120 and a bottom mold 140 so as to sufficiently secure the mechanical strength. This can solve the previous problem of a lack of cooling because the inlet was positioned at the hub.

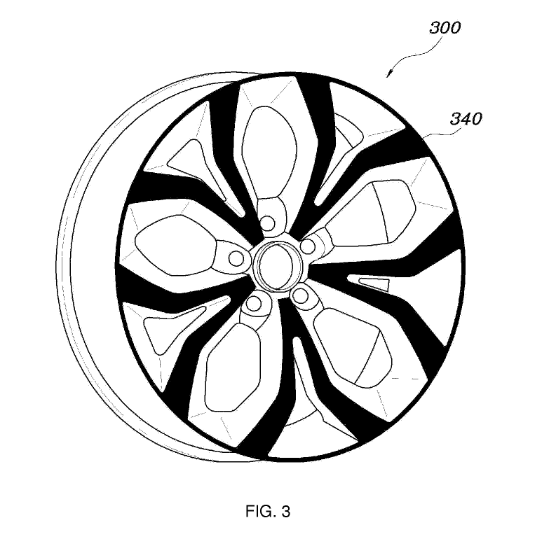

Further, the alloy of the present invention is a high strength, 330 Mpa-grade, alloy, which is higher in strength than the conventional casting alloy of 250˜280 Mpa. As shown in FIG. 2, by decreasing the thickness of the rear part of a wheel spoke 320, the aluminum wheel can beneficially be made more lightweight. For example, the weight of an aluminum wheel according to the present invention could be reduced about 5% (2.5 kg/car), as compared to the same aluminum wheel, by reducing the thickness of the rear part of the spoke.

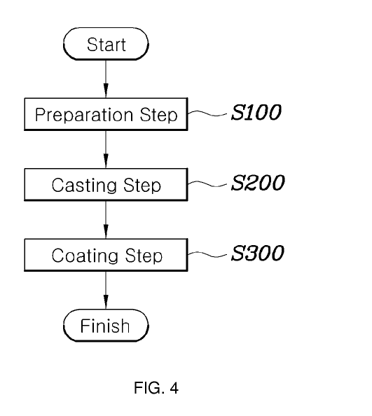

FIG. 3 is a perspective view of an aluminum wheel according to one embodiment of the present invention, and FIG. 4 is a flow chart showing a method of producing the aluminum wheel according to one embodiment of the present invention. According to the present invention, the aluminum wheel 300 of the present invention can be provided with a beautiful exterior design through color coating after anodizing treatment.

Specifically, in the aluminum wheel 300 of the present invention, coating quality is increased by color coating the outer most designed face 340, which is exposed to the outside, after anodizing treatment. As described above, this effect can be obtained by limiting the Si content, particularly to about 2 wt % or less, because Si is a major ingredient for securing fluidity of the molten metal and for increasing strength of a cast alloy. However, high Si content is an obstacle for forming an Al₂O₃ layer in an anodizing process, and causes uneven anodizing thickness and uneven color expression when coloring by anodizing.

Further, according to various embodiments, the aluminum wheel 300 can be colored again after coloring the wheel. In particular, after the wheel is colored, at least a portion of the coated layer of the outer most designed face 340 which is exposed to the outside is removed, the designed face 340 is then anodized, and recoated.

Namely, after processing the aluminum wheel, the aluminum wheel is generally prepared by base coating (powder or liquid primer)→middle coating (liquid color)→top coating (powder or liquid clear). The anodizing treatment can be conducted after processing the entire wheel, but generally, the anodizing treatment is conducted only at applicable parts according to the design on which color will be expressed. Accordingly, the anodizing treatment can be conducted after base coating and middle coating the wheel. After anodizing, the wheel can then be reprocessed, particularly by removing the base coated layer and middle coated layer from the designed face to remove the base coated layer and the middle coated layer.

Through this technique, anodizing can be carried out on only the portions where the base coated layer and the middle coated layer are removed, while the remainder (portions having the base coated layer and the top coated layer maintained thereon) are naturally prevented from anodizing. Similarly, when producing an aluminum wheel, a base coated layer and a middle coated (color) layer can be coated with various colors, while the anodized portions can be coated with different colors to produce a multi-color wheel which can further increase merchantability.

According to embodiments of the present invention, the anodizing is applied by the same method that is generally used for aluminum wrought alloy. In the case of anodizing a casting wheel, the anodized layer is formed unevenly due to the Si ingredient. Further, when coloring, the wheel is stained or displays a different color which results in low merchantability. On the other hand, the alloy used in the present invention provides an excellent anodizing layer and excellent color expression, particularly by using a low amount of Si, such as at a the minimum amount of no greater than about 2 wt %, even when the same anodizing method as used previously is carried out.

Shown in FIG. 4 is a flow chart of a method for producing an aluminum wheel according to one embodiment of the present invention. As shown, and the method for producing an aluminum wheel of the present invention comprises: a preparing step S100, a casting step S200, and a coating step S300 in sequence. According to an embodiment of the present invention, the method comprises a preparing step of preparing an aluminum alloy molten metal, which comprises: Al as a major ingredient, Si: about 0˜2 wt % (excluding 0 wt %), Fe : about 0˜0.15 wt % (excluding 0 wt%), Cu: about 0.5˜1 wt %, Mn: about 0.03˜0.2 wt %, Mg: about 0.8˜1.2 wt %, Cr: about 0.05˜0.35 wt %, Zn: about 0.2˜0.6 wt %, Ti: about 0.01˜0.1 wt %, Sr: about 0.001˜0.05 wt %, P: about 0˜0.001 wt %(excluding 0 wt %) and inevitable impurities; and a casting step of producing an aluminum wheel by using a casting mold.

Further, according to various aspects the casting step S200 is carried out by using a gravity tilt pour casting device 100, and molten metal 200 is poured from a rim part 180 of the aluminum wheel mold. And, the casting step S200 may further comprise a coating step S300 of color coating the produced aluminum wheel after anodizing treatment thereof.

In the coating step S300, the coated layer of the outer most designed face 340, which is exposed to the outside, may be partially or fully removed (i.e. removed to any extent) after color coating the produced aluminum wheel; and can then be anodized followed by color coating thereof again. In another embodiment, the outer most designed face, which is exposed to the outside, may be anodized followed by color coating thereof, as described above.

According to the present invention, an anodized wheel having an excellent anodizing layer and/or excellent color expression can be obtained by using low amounts of Si, such as levels at the minimum amount (e.g. no greater than 2 wt %), even when using the same anodizing method used previously. The present invention provides aluminum wheels with excellent merchantability.

Further, by using gravity tilt pour casting, strength around a hub of the aluminum wheel can be increased and a lightweight aluminum wheel can be produced.

Further, various colors can be expressed on a new low cost, high strength alloy, as compared with a forged material, and an aluminum wheel which is more lightweight than conventional aluminum wheels can be obtained by applying an anodizing technique.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. An aluminum wheel comprising: Al as a major ingredient, greater than 0 wt % and up to about 2 wt % Si, greater than 0 wt % and up to about 0.15 wt % Fe, about 0.5˜1 wt % Cu, about 0.03˜0.2 wt % Mn, about 0.8˜1.2 wt % Mg, about 0.05˜0.35 wt % Cr, about 0.2˜0.6 wt % Zn, about 0.01˜0.1 wt % Ti, about 0.001˜0.05 wt % Sr, greater than 0 wt % and up to about 0.001 wt % P, and inevitable impurities, wherein wt % are based on the total weight of the aluminum wheel.

2. The aluminum wheel according to claim 1, which is produced by pouring a molten metal of the Al, Si, Fe, Cu, Mn, Mg, Cr, Zn, Ti, Sr, P and inevitable impurities from a rim part of a gravity tilt pour casting device by using gravity tilt pour casting.

3. The aluminum wheel according to claim 1, wherein at least a portion thereof is anodized and color coated.

4. The aluminum wheel according to claim 1, wherein an outer most designed face of the aluminum wheel, which is exposed outside, is color coated after anodizing treatment.

5. The aluminum wheel according to claim 1, wherein an outer most designed face, which is exposed outside, is coated with a coating layer, at least portion of the coating layer is removed, followed by anodizing treatment and coloring the outer most designed face from which the coating layer has been removed.

6. A method for producing an aluminum wheel comprising:
a preparing step of preparing an aluminum alloy molten metal, which comprises: Al as a major ingredient, greater than 0 wt % and up to about 2 wt % Si, greater than 0 wt % and up to about 0.15 wt % Fe, about 0.5˜1 wt % Cu, about 0.03˜0.2 wt % Mn, about 0.8˜1.2 wt% Mg, about 0.05˜0.35 wt % Cr, about 0.2˜0.6 wt % Zr, about 0.01˜0.1 wt % Ti, about 0.001˜0.05 wt % Sr, greater than 0 wt % and up to about 0.001 wt % P and inevitable impurities; and
a casting step of producing an aluminum wheel from the molten metal by using a casting mold.

7. The method for producing an aluminum wheel according to claim 6, wherein the casting step comprises casting by pouring the molten metal from a rim part of an aluminum wheel mold by using a gravity tilt pour casting device.

8. The method for producing an aluminum wheel according to claim 6, wherein the casting step further comprises a coating step of color coating at least a portion of the produced aluminum wheel after anodizing treatment thereof to form a coated layer.

9. The method for producing an aluminum wheel according to claim 8, wherein the casting step further comprises, after color coating the produced aluminum wheel, removing at least a portion of the coated layer from an outer most designed face of the aluminum wheel, which is exposed outside; and then anodizing treatment followed by color coating the outer most designed face.

10. The method for producing an aluminum wheel according to claim 6, wherein the casting step further comprises a coating step of performing anodizing treatment on an outer most designed face of the aluminum wheel, followed by coating.
